(19) United States
(12) Patent Application Publication
(10) Pub. No.: US 2026/0366223 A1
(43) Pub. Date: Nov. 19, 2026

(54) WASHING PROCESSING DEVICE AND WASHING TUB CONTAMINATION PREVENTION METHOD THEREOF

(71) Applicant: LG ELECTRONICS INC., Seoul (KR)

(72) Inventors: Jaewan PARK, Seoul (KR); Eungmin LEE, Seoul (KR); Katsuyoshi HIRAKI, Seoul (KR); Noriyuki MISHINA, Seoul (KR)

(73) Assignee: LG ELECTRONICS INC., Seoul (KR)

(21) Appl. No.: 19/147,932

(22) PCT Filed: Jan. 30, 2023
(86) PCT No.: PCT/KR2023/001359

§ 371 Date: Jul. 14, 2025

(51) Int. Cl. D06F 39/06; B08B 3/10; D06F 39/08; D06F 103/68; D06F 105/02

(52) U.S. Cl. CPC D06F 39/06; B08B 3/10; D06F 39/088; D06F 2103/68; D06F 2105/02

(57) ABSTRACT

The present disclosure relates to a washing treatment device having a function of preventing contamination of a washing tub and a method for preventing contamination of a washing tub thereof, and the washing treatment device includes a washing tub in which laundry is stored; a fine bubble water generation part that generates fine bubble water; a water supply part that supplies the fine bubble water between an outer tub and an inner tub of the washing tub; and, a control part that controls the fine bubble water generation part and the water supply part, in which the control part may obtain operation information of the washing tub, determine whether to supply the fine bubble water based on the operation information of the washing tub, and if it is determined to supply the fine bubble water, control the fine bubble water generation part to generate the fine bubble water, and control the water supply part to supply the generated fine bubble water to the inside of the outer tub and the outside of the inner tub of the washing tub.

### TECHNICAL FIELD

The present disclosure relates to a washing treatment device having a function of preventing contamination of a washing tub and a method for preventing contamination of a washing tub thereof.

### BACKGROUND ART

In general, a washing treatment device can include an appliance that washes and/or dehydrates laundry.

A washing treatment device can wash and/or dehydrate laundry by rotating a washing tub in which laundry is stored.

In this way, the washing treatment device can separate and remove contaminants attached to the laundry by placing laundry and cleaning water in the washing tub and rotating the washing tub, through friction and impact between the laundry and cleaning water.

However, since there is no friction or impact with laundry between the inner surface of the outer tub and the outer surface of the inner tub of the washing tub and the gap between them is narrow, making it difficult to clean for maintenance, contaminants that cause scale are easily attached and deposited, causing an unpleasant odor.

Therefore, in the future, it is necessary to develop a washing treatment device that can maintain cleanliness by preventing contamination of the washing tub with a small amount of water.

### DISCLOSURE

### Technical Problem

An object of the present disclosure is to solve the above-mentioned problems and other problems.

An object of the present disclosure is to provide a washing treatment device capable of preventing contamination of a washing tub with a small amount of water and maintaining cleanliness by generating fine bubble water based on operation information of the washing tub and supplying the same to the inner surface of the outer tub and the outer surface of the inner tub, and a method for preventing contamination of the washing tub thereof.

### Technical Solution

According to an embodiment of the present disclosure, a washing treatment device includes a washing tub in which laundry is stored; a fine bubble water generation part that generates fine bubble water; a water supply part that supplies the fine bubble water between an outer tub and an inner tub of the washing tub; and, a control part that controls the fine bubble water generation part and the water supply part, in which the control part may obtain operation information of the washing tub, determine whether to supply the fine bubble water based on the operation information of the washing tub, and if it is determined to supply the fine bubble water, control the fine bubble water generation part to generate the fine bubble water, and control the water supply part to supply the generated fine bubble water to the inside of the outer tub and the outside of the inner tub of the washing tub.

According to an embodiment of the present disclosure, a method for preventing contamination of a washing tub of a washing treatment device including a washing tub may include obtaining operation information of the washing tub; determining the supply of the fine bubble water based on the operation information of the washing tub; generating the fine bubble water; and supplying the generated fine bubble water to the inside of the outer tub and the outside of the inner tub of the washing tub.

### Advantageous Effect

According to one embodiment of the present disclosure, a washing treatment device generates fine bubble water based on operation information of a washing tub and supplies the fine bubble water to the inner surface of the outer tub and the outer surface of the inner tub of a washing tub, thereby preventing contamination of the washing tub with a small amount of water and maintaining cleanliness.

In addition, the present disclosure can maintain the hygiene of a washing treatment device by removing the cause of an unpleasant odor, and improve user convenience by eliminating the need for regular maintenance and an independent washing tub cleaning course, thereby increasing customer satisfaction.

In addition, the present disclosure can minimize environmental contamination through water conservation by using a small amount of fine bubble water.

In addition, since the present disclosure enables supply of fine bubble water without an additional device such as a pump, the unit price of the product can be minimized.

### DESCRIPTION OF DRAWINGS

FIGS. 1 and 2 are block diagrams for explaining a washing treatment device according to one embodiment of the present disclosure.

FIGS. 3 and 4 are views for explaining a washing treatment device according to one embodiment of the present disclosure.

FIGS. 5 and 6 are views for explaining a method for supplying fine bubble water to a washing treatment device according to one embodiment of the present disclosure.

FIGS. 7 and 8 are drawings for explaining the arrangement of a supply part of a washing treatment device according to one embodiment of the present disclosure.

FIG. 9 is a block diagram illustrating a washing treatment device according to another embodiment of the present disclosure.

FIGS. 10 and 11 are block diagrams illustrating a washing treatment device according to another embodiment of the present disclosure.

FIG. 12 is a drawing for explaining the timing control of the supply of fine bubble water of a washing treatment device according to one embodiment of the present disclosure.

FIGS. 13 and 14 are views for explaining the effect of preventing contamination of a washing tub of a washing treatment device according to one embodiment of the present disclosure.

FIG. 15 is a flowchart for explaining a method for preventing contamination of a washing tub of a washing treatment device according to an embodiment of the present disclosure.

### BEST MODEL

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly interlocked’ to another component, it means that no intervening component is present.

Also, throughout this specification, a neural network and a network function may be used interchangeably. The neural network may be constituted by a set of interlocked computational units, which may be generally referred to as “nodes”. These “nodes” may also be referred to as “neurons”. The neural network is configured to include at least two or more nodes. Nodes (or neurons) constituting neural networks may be interlocked by one or more “links”.

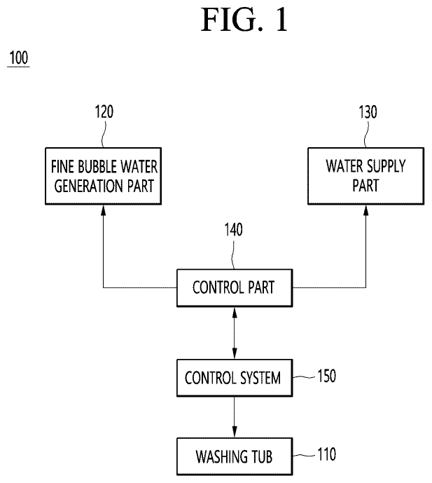

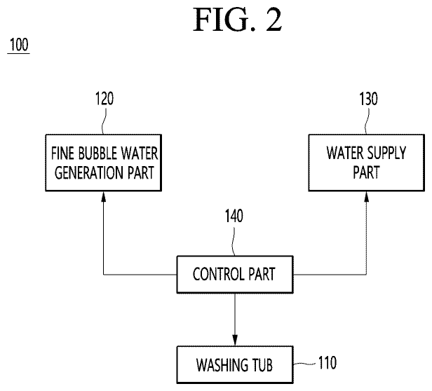

FIGS. 1 and 2 are block diagrams for explaining a washing treatment device according to one embodiment of the present disclosure.

As illustrated in FIGS. 1 and 2, the washing treatment device 100 of the present disclosure can include a washing tub 110 in which laundry is stored, a fine bubble water generation part 120 that generates fine bubble water, a water supply part 130 that supplies fine bubble water between the outer tub and the inner tub of the washing tub 110, and a control part 140 that controls the fine bubble water generation part 120 and the water supply part 130.

Here, the fine bubble water generation part 120 can be placed outside the outer tub of the washing tub 110 and can be connected to the water supply part 130 through a duct through which the fine bubble water flows.

For example, a duct can connect the water outlet part of a fine bubble water generation part 120 from which fine bubble water is discharged and the water inlet part of a water supply part 130 from which fine bubble water is received.

In addition, the fine bubble water generation part 120 can generate fine bubble water including micro-sized or smaller bubbles according to the control signal of the control part 140 and supply the generated fine bubble water to the water supply part 130 through a duct.

For example, the fine bubble water generation part 120 can use a cavitation method that generates fine bubbles from dissolved oxygen in water through cavitation, but this is only one example and is not limited thereto.

Here, the fine bubble water generation part 120 is directly connected to the water pipe and can provide pressure for fine bubble generation by utilizing the water pressure inside the water pipe.

In some cases, the fine bubble water generation part 120 can use a circulating fluid flow method that sucks in gas due to a pressure difference caused by the generation of a vortex and generates fine bubbles when the vortex collapses.

In another case, the fine bubble water generation part 120 can use a pressurized dissolution method that puts gas and liquid in a tank, dissolves them under strong pressure, and then exposes them to atmospheric pressure to generate fine bubbles.

As another case, the fine bubble water generation part 120 can use a micro-pore injection method that generates fine bubbles by injecting gas into micro-pores.

Next, the water supply part 130 can be placed in the outer tub of the washing tub 110, and can include a water inlet part through which fine bubble water is received from the fine bubble water generation part 120, and a water outlet part through which fine bubble water is discharged to the inner surface of the outer tub and the outer surface of the inner tub of the washing tub 110.

Here, the water intake part of the water supply part 130 can be located on the outer surface of the outer tub of the washing tub 110, and the water outlet part of the water supply part 130 can be located on the inner surface of the outer tub of the washing tub.

For example, the water outlet part of the water supply part 130 can have a disc shape that sprays fine bubble water in all directions, but this is only one example and is not limited thereto.

As another example, the water outlet part of the water supply part 130 can have a stripe shape that sprays fine bubble water in both directions, but this is only one example and is not limited thereto.

Additionally, one or more water supply parts 130 can be placed in the outer tub of the washing tub 110.

Here, one water supply part 130 can be placed in the central region of the upper end part of the outer tub of the washing tub 110.

In some cases, a plurality of water supply parts 130 can be placed one each in the central region of the upper end part of the outer tub and the central region of the middle end part of the outer tub of the washing tub 110.

In another case, a plurality of water supply parts 130 can be arranged one each in the central region of the upper end part of the outer tub, the central region of the middle end part of the outer tub, and the central region of the lower end part of the outer tub of the washing tub 110.

Next, the control part 140 obtains operation information of the washing tub 110, determines whether to supply fine bubble water based on the operation information of the washing tub 110, and if it is determined to supply fine bubble water, controls the fine bubble water generation part 120 to generate fine bubble water, and controls the water supply part 130 to supply the generated fine bubble water to the inner surface of the outer tub and the outer surface of the inner tub of the washing tub 110.

Here, when obtaining operation information of the washing tub 110, as illustrated in FIG. 1, the control part 140 can obtain operation information including the current stroke state of the washing tub 110 from the control system 150 that controls the operation of the washing tub 110.

For example, the operation information of the washing tub 110 can include the current stroke state of the washing tub, which is one of a detergent washing stroke state, a rinsing stroke state, a spin-drying stroke state, and an intermediate stroke state between a previous stroke state and a next stroke state, but this is only an example and is not limited thereto.

In some cases, when obtaining operation information of the washing tub 110, the control part 140 can, as illustrated in FIG. 2, when receiving a user input for selecting at least one washing menu from among a plurality of washing menus, check the stroke sequence and the time for each stroke corresponding to the selected washing menu, and when an operation command is input, obtain the operation information of the washing tub 110 based on the stroke sequence and the time for each stroke, and control the operation of the washing tub 110 accordingly.

For example, the operation information of the washing tub can include one of a detergent washing stroke state, a rinsing operation state, a spin-drying stroke state, and an intermediate stroke state between a previous stroke and a next stroke, but this is only an example and is not limited thereto.

In another case, when obtaining operation information of the washing tub, as illustrated in FIG. 2, when the preset time arrives, the control part 140 can check the stroke sequence and the time for each stroke corresponding to the preset washing menu, obtain the operation information of the washing tub based on the stroke sequence and the time for each stroke, and control the operation of the washing tub 110 accordingly.

For example, the operation information of the washing tub 110 can include any one of a detergent washing stroke state, a rinsing stroke state, a spin-drying stroke state, and an intermediate stroke state between a previous operation and a next operation, but this is only an example and is not limited thereto.

Next, the control part 140, when determining whether to supply fine bubble water, can check the current stroke state of the washing tub 110 based on the operation information of the washing tub 110, check whether the current stroke state is a fine bubble water supply stroke, and if the current stroke state is a fine bubble water supply stroke, determine the supply of fine bubble water.

Here, the control part 140, when determining the supply of fine bubble water, can check whether a table of fine bubble water supply conditions for each pre-set stroke state exists, and if a table of fine bubble water supply conditions for each pre-set stroke state exists, extract a fine bubble water supply condition corresponding to the current stroke state, and determine the supply amount and supply time of fine bubble water corresponding to the extracted fine bubble water supply condition.

For example, the fine bubble water supply condition table can include a first fine bubble water supply condition corresponding to a detergent washing state, a second fine bubble water supply condition corresponding to a rinsing state, a third fine bubble water supply condition corresponding to a dehydration state, a fourth fine bubble water supply condition corresponding to an intermediate state between the detergent washing state and the rinsing state, and a fifth fine bubble water supply condition corresponding to an intermediate state between the rinsing state and the dehydration state, but this is only an example and is not limited thereto.

In addition, the control part 140 can determine the supply amount and supply time of fine bubble water corresponding to the basic supply conditions set as default if there is no table of fine bubble water supply conditions by preset stroke status.

In addition, when determining the supply amount and supply time of fine bubble water, the control part 140 can determine to increase the supply amount and supply time of fine bubble water if the current stroke state of the washing tub is an stroke state using highly contaminated washing water, and can determine to decrease the supply amount and supply time of fine bubble water if the current stroke state of the washing tub is an stroke state using low-contaminated washing water or not using washing water.

Here, the control part 140 can recognize that the current stroke state of the washing tub 110 is a process using high-contamination water if it is one of the detergent washing stroke state, the rinsing stroke state, and the intermediate stroke state between the detergent washing stroke state and the rinsing stroke state, and can recognize that the current stroke state of the washing tub is a process using low-contamination water if it is the dehydration stroke state or the intermediate stroke state between the rinsing stroke state and the dehydration stroke state.

In another embodiment, the washing treatment device 100 of the present disclosure can further include a contamination level measuring sensor part that is disposed between the outer drum and the inner drum of the washing drum 110 and measures the contamination level of the inner surface of the outer tub and the outer surface of the inner tub.

Here, when determining whether to supply fine bubble water, the control part 140 can obtain contamination level information of the washing tub from the contamination level measuring sensor part and determine the supply of fine bubble water based on the contamination level information of the washing tub.

For example, when obtaining contamination level information of the washing tub 110, the control part 140 can check whether the contamination level of the washing tub 110 is equal to or greater than a preset reference value, and if it is greater than the reference value, the contamination level of the washing tub can determine to supply fine bubble water.

In addition, when determining the supply of fine bubble water, the control part 140 can check whether a table of fine bubble water supply conditions by preset contamination level exists, and if a table of fine bubble water supply conditions by preset contamination level exists, extract the fine bubble water supply conditions corresponding to the current contamination level, and determine the supply amount and supply time of fine bubble water corresponding to the extracted fine bubble water supply conditions.

Next, when determining whether to supply fine bubble water, the control part 140 can check the current stroke state of the washing tub 110 based on the operation information of the washing tub 110, check whether the current stroke state is a fine bubble water supply state, and if the current stroke state is a fine bubble water supply state, obtain contamination level information of the washing tub 110 from the contamination level measurement sensor part, and determine the supply of fine bubble water based on the contamination level information of the washing tub 110.

For example, when determining whether to supply fine bubble water, the control part 140 can determine to supply fine bubble water if the current stroke state is a fine bubble water supply stroke and the contamination level of the washing tub 110 is equal to or greater than a preset reference value, and can determine not to supply fine bubble water if the current stroke state is a fine bubble water supply stroke and the contamination level of the washing tub 110 is lower than a preset reference value.

As another example, when determining whether to supply fine bubble water, the control part 140 can determine to supply fine bubble water if the current stroke state is not a fine bubble water supply stroke and the contamination level of the washing tub 110 is equal to or greater than a preset reference value, and determine not to supply fine bubble water if the current stroke state is not a fine bubble water supply stroke and the contamination level of the washing tub 110 is lower than a preset reference value.

In addition, when the contamination level measurement sensor parts are each placed at the upper end part pf the inside of the outer tub, the middle end part of inside of the outer tub, and the lower end part of the inside of the outer tub of the washing tub 110, the control part 140 can obtain contamination level information for each part of the washing tub 110 from the plurality of contamination level measurement sensor parts, and determine the supply of fine bubble water based on the contamination level information for each part of the washing tub 110.

In addition, when the contamination level measurement sensor parts are respectively arranged at the upper end part of the inside of the outer tub, the middle end part of the inside of the outer tub, and the lower end part of the inside of the outer tub of the washing tub 110, and the water supply parts 130 are respectively arranged at the central region of the upper end part of the outer tub, at the central region of the middle end part of the outer tub, and at the central region of the lower end part of the outer tub of the washing tub 110, the control part 140 can obtain contamination level information for each part of the washing tub 110 from the plurality of contamination level measurement sensor parts, and determine the supply of fine bubble water through at least one of the plurality of water supply parts based on the contamination level information for each part of the washing tub 110.

In another embodiment, the present disclosure can include a display part that displays contamination alarm information.

Here, the control part 140 can control the display part to generate and display contamination alarm information when the contamination level of the washing tub 110 is equal to or greater than a preset reference value.

For example, the contamination alarm information can include contamination level values of the inner surface of the outer tub and the outer surface of the inner tub, a message asking whether to supply fine bubble water to remove contamination from the washing tub, and user selection button information for entering a fine bubble water supply command, but this is only an example and is not limited thereto.

At this time, the control part 140 can determine the supply of fine bubble water when the user's fine bubble water supply command is input after the contamination alarm information is displayed.

In addition, the control part 140 can automatically determine the supply of fine bubble water if the user's fine bubble water supply command is not input within a predetermined time after the contamination alarm information is displayed.

In another embodiment, the present disclosure can include a memory part that stores user washing history information.

Here, when determining whether to supply fine bubble water, the control part 140 can obtain user washing history information from the memory part and determine the supply of fine bubble water based on the user washing history information.

In addition, when obtaining user washing history information, the control part 140 can calculate the total number of times and total time corresponding to the stroke using highly contaminated water among the washing strokes performed by the user during the past set period, check whether at least one of the total number of times and total time is equal to or greater than a preset reference value, and if it is greater than the reference value, determine the supply of fine bubble water.

Here, when determining the supply of fine bubble water, the control part 140, the control part 140 can check whether a table of preset total number of times and total time-based fine bubble water supply conditions exists, and if a table of preset total number of times and total time-based fine bubble water supply conditions exists, extract a fine bubble water supply condition corresponding to the current contamination level, and determine the fine bubble water supply amount and supply time corresponding to the extracted fine bubble water supply condition.

In addition, when determining whether to supply fine bubble water, the control part 140 can check the current stroke state of the washing tub 110 based on the operation information of the washing tub 110, check whether the current stroke state is a fine bubble water supply stroke, and if the current stroke state is a fine bubble water supply stroke, obtain user washing history information from the memory part, and determine the supply of fine bubble water based on the user washing history information.

For example, when determining whether to supply fine bubble water, the control part 140 can determine to supply fine bubble water if the current stroke state is a fine bubble water supply stroke state and at least one of the total number of times and the total time corresponding to the stroke state using highly contaminated washing water is equal to or greater than a preset reference value, determine not to supply fine bubble water if the current stroke state is a fine bubble water supply stroke state and at least one of the total number of times and the total time corresponding to the stroke state using highly contaminated washing water is less than a preset reference value.

As another example, when determining whether to supply fine bubble water, the control part 140 can determine to supply fine bubble water if the current stroke state is not a fine bubble water supply stroke state and at least one of the total number of times and the total time corresponding to an stroke state using highly contaminated washing water is equal to or greater than a preset reference value, and determine not to supply fine bubble water if the current stroke state is not a fine bubble water supply stroke state and at least one of the total number of times and the total time corresponding to an stroke state using highly contaminated washing water is less than a preset reference value.

As another embodiment, when determining whether to supply fine bubble water, the control part 140 can input operation information of the washing tub 110 into a pre-learned neural network model to obtain a contamination level prediction result of the washing tub 110, and determine the supply of fine bubble water based on the contamination level prediction result of the washing tub 110.

Here, the operation information of the washing tub can include the current stroke state of the washing tub 110, which is one of the detergent washing stroke state, the rinsing stroke state, the spin-drying stroke state, and the intermediate stroke state between the previous stroke state and the next stroke state, but this is only an example and is not limited thereto.

In addition, the neural network model can be pre-trained to predict the contamination level for each washing stroke when input information including at least one of operation information for each washing stroke, number for each washing stroke, and time for each washing stroke of a washing tub is input.

In addition, the control part 140 can check whether a table of fine bubble water supply conditions according to a preset contamination level prediction result exists when determining the supply of fine bubble water, and if a table of fine bubble water supply conditions according to a preset contamination level prediction result exists, extract a fine bubble water supply condition corresponding to the current contamination level, and determine the fine bubble water supply amount and supply time corresponding to the extracted fine bubble water supply condition.

Next, the control part 140, when controlling the fine bubble water generation part 120 and the water supply part 130, can obtain the fine bubble water supply conditions when the fine bubble water supply is determined, and can control the fine bubble water generation of the fine bubble water generation part 120 and the opening and closing of the water supply part 130 based on the fine bubble water supply amount and supply time corresponding to the fine bubble water supply conditions.

The fine bubble water of the present disclosure can prevent contaminants from attaching or depositing or remove contaminants already attached by being supplied to the inner surface of the outer tub and the outer surface of the inner tub of the washing tank.

For example, if fine bubble water is supplied to the inner surface of the outer tub and the outer surface of the inner tub before contaminants are attached or deposited, the fine bubbles coated on the washing tub can act as a hindrance factor that blocks the attachment or deposition of contaminants, thereby causing contaminants, such as scale, to become porous and reduce their adhesion to the washing tub.

As another example, when fine bubble water is supplied to the inner surface of the outer tub and the outer surface of the inner tub after contaminants have been attached or deposited, the contaminants can be easily removed due to the shock wave or crushing effect generated by the destruction of the fine bubbles.

In this way, the present disclosure generates fine bubble water based on operation information of a washing tub and supplies it to the inner surface of the outer tub and the outer surface of the inner tub of the washing tub, thereby preventing contamination of the washing tub with a small amount of water and maintaining cleanliness.

In addition, the present disclosure can maintain the hygiene of a washing treatment device by removing the cause of an unpleasant odor, and improve user convenience by eliminating the need for regular maintenance and an independent washing tub cleaning course, thereby increasing customer satisfaction.

In addition, the present disclosure can minimize environmental contamination through water saving by using a small amount of fine bubble water.

In addition, since the present disclosure enables supply of fine bubble water without an additional device such as a pump, the unit price of the product can be minimized.

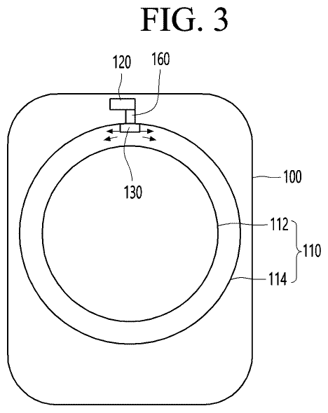

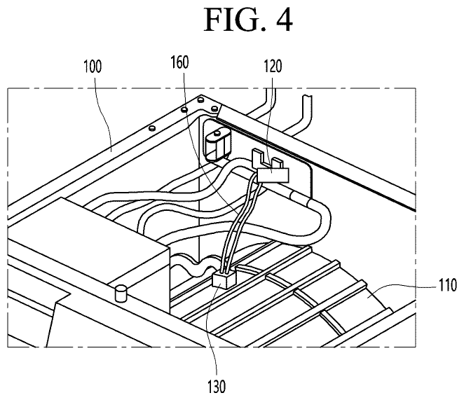

FIGS. 3 and 4 are views for explaining a washing treatment device according to one embodiment of the present disclosure.

As illustrated in FIGS. 3 and 4, the washing treatment device 100 of the present disclosure can include a washing tub 110 in which laundry is stored, a fine bubble water generation part 120 that generates fine bubble water, and a water supply part that supplies fine bubble water between the outer tub 114 and the inner tub 112 of the washing tub 110.

Here, the fine bubble water generation part 120 can be placed outside the outer tub 114 of the washing tub 110 and can be connected to the water supply part 130 through a duct 160 through which the fine bubble water flows.

For example, a duct 160 can connect between a water outlet part of a fine bubble water generation part 120 from which fine bubble water is discharged and a water inlet part of a water supply part 130 from which fine bubble water is received.

In addition, the fine bubble water generation part 120 can generate fine bubble water containing micro-sized or smaller bubbles according to a control signal and supply the generated fine bubble water to the water supply part 130 through a duct 160.

Next, the water supply part 130 can be placed in the outer tub 114 of the washing tub 110.

Here, the water supply part 130 can include a water inlet part through which fine bubble water is received from the fine bubble water generation part 120, and a water outlet part through which fine bubble water is discharged to the inner surface of the outer tub 114 and the outer surface of the inner tub 112 of the washing tub 110.

Here, the water inlet part of the water supply part 130 can be located on the outer surface of the outer tub 114 of the washing tub 110, and the water outlet part of the water supply part 130 can be located on the inner surface of the outer tub 114 of the washing tub 110.

In addition, one or more water supply parts 130 can be placed in the outer tub 114 of the washing tub 110.

Here, one water supply part 130 can be placed in the central region of the upper end part of the outer tub 114 of the washing tub 110.

In some cases, a plurality of water supply parts 130 can be arranged one each in the central region of the upper end part of the outer tub 114 of the washing tub 110 and the central region of the middle end part of the outer tub 114.

In another case, a plurality of water supply parts 130 can be arranged one each in the central region of the upper end part of the outer tub 114 of the washing tub 110, the central region of the middle end part of the outer tub 114, and the central region of the lower end part of the outer tub 114.

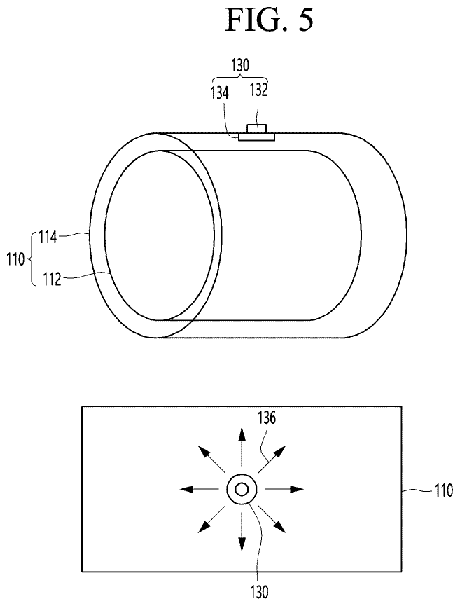

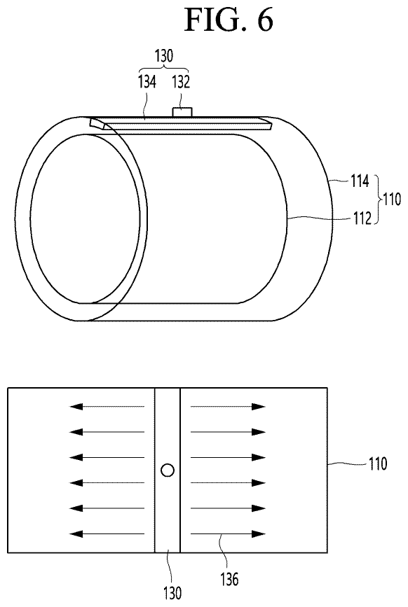

FIGS. 5 and 6 are views for explaining a method for supplying fine bubble water to a washing treatment device according to one embodiment of the present disclosure.

As illustrated in FIG. 5, the water supply part 130 can include a water inlet part 132 through which fine bubble water 136 is received, and a water outlet part 134 through which fine bubble water 136 is discharged to the inner surface of the outer tub 114 and the outer surface of the inner tub 112 of the washing tub 110.

Here, the water inlet part 132 of the water supply part 130 can be located on the outer surface of the outer tub 114 of the washing tub 110, and the water outlet part 134 of the water supply part 130 can be located on the inner surface of the outer tub 114 of the washing tub 110.

At this time, the water outlet part 134 of the water supply part 130 can have a disc shape that sprays fine bubble water 136 in all directions.

For example, the water supply part 130 can be placed in the central region of the upper end part of the outer tub 114 of the washing tub 110.

In some cases, as illustrated in FIG. 6, the water outlet part 134 of the water supply part 130 can have a stripe shape that sprays fine bubble water 136 in both directions.

Here, fine bubble water 136 is supplied to the inner surface of the outer tub 114 and the outer surface of the inner tub 112 of the washing tub 110, thereby preventing contaminants from being attached or deposited, or removing contaminants that have already been attached.

For example, if fine bubble water 136 is supplied to the inner surface of the outer tub 114 and the outer surface of the inner tub 112 before contaminants are attached or deposited, the fine bubbles coated on the washing tub 110 act as a hindrance factor that blocks the attachment or deposition of contaminants, so that contaminants represented by scale can become porous and reduce the adhesion to the washing tub 110.

As another example, when fine bubble water 136 is supplied to the inner surface of the outer tub 114 and the outer surface of the inner tub 112 after contaminants are attached or deposited, the contaminants can be easily removed due to the shock wave or crushing effect generated by the destruction of the fine bubbles.

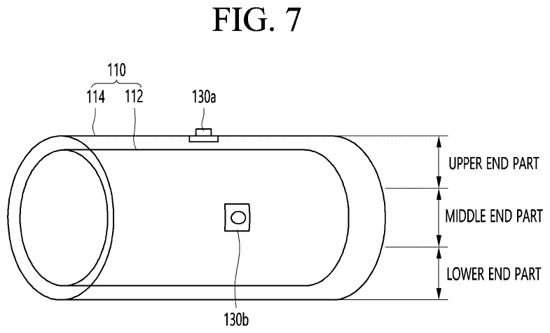

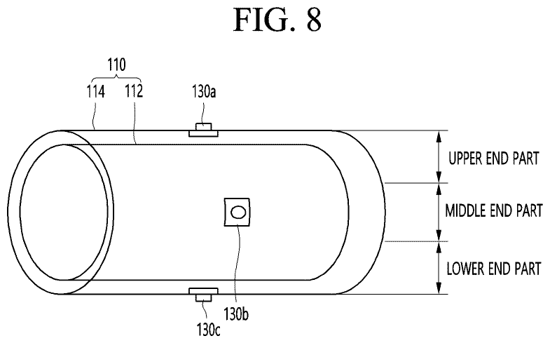

FIGS. 7 and 8 are drawings for explaining the arrangement of a supply part of a washing treatment device according to one embodiment of the present disclosure.

As illustrated in FIGS. 7 and 8, a plurality of water supply parts 130 can be placed in the outer tub 114 of the washing tub 110.

Here, the plurality of water supply parts 130 can include, as illustrated in FIG. 7, a first water supply part 130a at least one of which is arranged in the central region of the upper end part of the outer tub 114 of the washing tub 110, and a second water supply part 130b at least one of which is arranged in the central region of the middle end part of the outer tub 114 of the washing tub 110.

In another case, the plurality of water supply parts 130 can include, as illustrated in FIG. 8, a first water supply part 130a at least one of which is arranged in the central region of the upper end part of the outer tub 114 of the washing tub 110, a second water supply part 130b at least one of which is arranged in the central region of the middle end part of the outer tub 114 of the washing tub 110, and a third water supply part 130c at least one of which is arranged in the central region of the lower end part of the outer tub 114 of the washing tub 110.

In this way, the present disclosure can prevent contaminants from being attached or deposited or remove contaminants already attached by uniformly supplying water to the inner surface of the outer tub 114 and the outer surface of the inner tub 112 of the washing tub 110 by arranging a plurality of water supply parts 130.

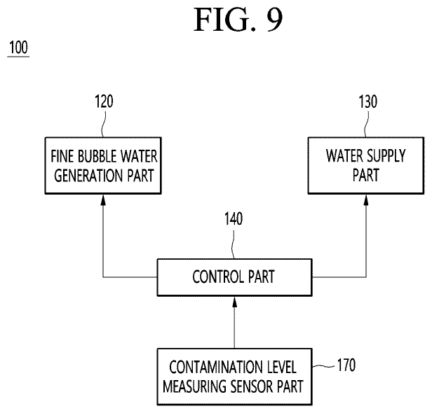

FIG. 9 is a block diagram illustrating a washing treatment device according to another embodiment of the present disclosure.

As illustrated in FIG. 9, the washing treatment device 100 of the present disclosure can include a fine bubble water generation part 120 that generates fine bubble water, a water supply part 130 that supplies fine bubble water between the outer tub and the inner tub of a washing tub, a contamination level measuring sensor part 170 that is arranged between the outer tub and the inner tub of the washing tub and measures the contamination level of the inner surface of the outer tub and the outer surface of the inner tub, and a control part 140 that controls the fine bubble water generation part 120 and the water supply part 130.

Here, the control part 140 can obtain operation information of the washing tub, determine whether to supply fine bubble water based on the operation information of the washing tub, and if it is determined to supply fine bubble water, control the fine bubble water generation part 120 to generate fine bubble water, and control the water supply part 130 to supply the generated fine bubble water to the inner surface of the outer tub and the outer surface of the inner tub of the washing tub.

In addition, when determining whether to supply fine bubble water, the control part 140 can obtain contamination level information of the washing tub from the contamination level measuring sensor part 170 and determine the supply of fine bubble water based on the contamination level information of the washing tub.

For example, when obtaining information on the contamination level of the washing tub, the control part 140 can check whether the contamination level of the washing tub is equal to or greater than a preset reference value, and if the contamination level of the washing tub is equal to or greater than the reference value, determine to supply fine bubble water.

In addition, when determining the supply of fine bubble water, the control part 140 can check whether a table of fine bubble water supply conditions by preset contamination level exists, and if a table of fine bubble water supply conditions by preset contamination level exists, extract the fine bubble water supply conditions corresponding to the current contamination level, and determine the supply amount and supply time of fine bubble water corresponding to the extracted fine bubble water supply conditions.

Next, the control part 140, when determining whether to supply fine bubble water, can check the current stroke state of the washing tub based on the operation information of the washing tub, check whether the current stroke state is a fine bubble water supply stroke state, and if the current stroke state is a fine bubble water supply stroke state, obtain contamination level information of the washing tub from the contamination level measurement sensor part 170, and determine the supply of fine bubble water based on the contamination level information of the washing tub.

For example, when determining whether to supply fine bubble water, the control part 140 can determine to supply fine bubble water if the current stroke state is a fine bubble water supply stroke and the contamination level of the washing tub is equal to or greater than a preset reference value, and determine not to supply fine bubble water if the current stroke state is a fine bubble water supply stroke and the contamination level of the washing tub is lower than a preset reference value.

As another example, when determining whether to supply fine bubble water, the control part 140 can determine to supply fine bubble water if the current stroke state is not a fine bubble water supply stroke and the contamination level of the washing tub is equal to or greater than a preset reference value, and can determine not to supply fine bubble water if the current stroke state is not a fine bubble water supply stroke and the contamination level of the washing tub is lower than a preset reference value.

In addition, in the present disclosure, when one contamination level measuring sensor part 170 is arranged at each of the upper end part of inner side of the outer tub, the middle end part of the inner side of the outer tub, and the lower end part of the inner side of the outer tub, the control part 140 can obtain contamination level information for each part of the washing tub from a plurality of contamination level measuring sensor parts 170 and determine the supply of fine bubble water based on the contamination level information for each part of the washing tub.

In addition, in the present disclosure, when one contamination level measurement sensor part 170 is arranged at each of the upper end part of the inner side of the outer tub, the middle end part of the inner side of the outer tub, and the lower end part of the inner side of the outer tub, and one water supply part 130 is disposed at each of the central region of the upper end part of the outer tub, the central region of the middle end part of the outer tub, and the central region of the lower end part of the outer tub, the control part 140 can obtain contamination level information for each part of the washing tub from a plurality of contamination level measurement sensor parts 170, and determine the supply of fine bubble water through at least one of the plurality of water supply parts based on the contamination level information for each part of the washing tub.

In some cases, the present disclosure can include a display part that displays contamination alarm information.

Here, the control part 140 can control the display part to generate and display contamination alarm information when the contamination level of the washing tub is equal to or greater than a preset reference value.

For example, the contamination alarm information can include contamination level values of the inner surface of the outer tub and the outer surface of the inner tub, a message asking whether to supply fine bubble water to remove contamination from the washing tub, and user selection button information for entering a fine bubble water supply command, but this is only an example and is not limited thereto.

At this time, the control part 140 can determine the supply of fine bubble water when the user's fine bubble water supply command is input after the contamination alarm information is displayed.

In addition, the control part 140 can automatically determine the supply of fine bubble water if the user's fine bubble water supply command is not input within a predetermined time after the contamination alarm information is displayed.

As another example, the present disclosure can include a memory part that stores user washing history information.

Here, when determining whether to supply fine bubble water, the control part 140 can obtain user washing history information from the memory part and determine the supply of fine bubble water based on the user washing history information.

In addition, when obtaining user washing history information, the control part 140 can calculate the total number of times and total time corresponding to the stroke using highly contaminated washing water among the washing strokes performed by the user during the past set period, check whether at least one of the total number of times and total time is equal to or greater than a preset reference value, and if it is equal to or greater than the reference value, determine the supply of fine bubble water.

Here, the control part 140 can check whether a table of pre-set total number of times and total time-based fine bubble water supply conditions exists when determining the supply of fine bubble water, and if a table of pre-set total number of times and total time-based fine bubble water supply conditions exists, extract a fine bubble water supply condition corresponding to the current contamination level, and determine the fine bubble water supply amount and supply time corresponding to the extracted fine bubble water supply condition.

In addition, when determining whether to supply fine bubble water, the control part 140 can check the current stroke state of the washing tub based on the operation information of the washing tub, check whether the current stroke state is a fine bubble water supply stroke, and if the current stroke state is a fine bubble water supply stroke, obtain user washing history information from the memory part and determine the supply of fine bubble water based on the user washing history information.

For example, when determining whether to supply fine bubble water, the control part 140 can determine to supply fine bubble water if the current stroke state is a fine bubble water supply stroke state and at least one of the total number of times and the total time corresponding to the stroke state using highly contaminated washing water is equal to or greater than a preset reference value, and determine not to supply fine bubble water if the current stroke state is a fine bubble water supply stroke state and at least one of the total number of times and the total time corresponding to the stroke state using highly contaminated washing water is less than a preset reference value.

As another example, when determining whether to supply fine bubble water, the control part 140 can determine to supply fine bubble water if the current stroke state is not a fine bubble water supply stroke state and at least one of the total number of times and the total time corresponding to an stroke state using highly contaminated washing water is equal to or greater than a preset reference value, and determine not to supply fine bubble water if the current stroke state is not a fine bubble water supply stroke state and at least one of the total number of times and the total time corresponding to an stroke state using highly contaminated washing water is less than a preset reference value.

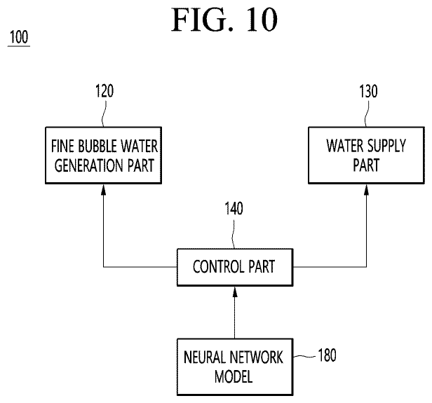

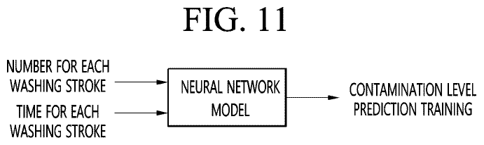

FIGS. 10 and 11 are block diagrams illustrating a washing treatment device according to another embodiment of the present disclosure.

As illustrated in FIGS. 10 and 11, the washing treatment device 100 of the present disclosure can include a fine bubble water generation part 120 that generates fine bubble water, a water supply part 130 that supplies fine bubble water between an outer tub and an inner tub of a washing tank, a pre-learned neural network model 180 that provides a contamination level prediction result of a washing tank based on operation information of the washing tank, and a control part 140 that controls the fine bubble water generation part 120 and the water supply part 130.

Here, the control part 140 can obtain operation information of the washing tub, determine whether to supply fine bubble water based on the operation information of the washing tub, if it is determined to supply fine bubble water, control the fine bubble water generation part 120 to generate fine bubble water, and control the water supply part 130 to supply the generated fine bubble water to the inner surface of the outer tub and the outer surface of the inner tub of the washing tub.

In addition, when determining whether to supply fine bubble water, the control part 140 can input the operation information of the washing tub into a pre-learned neural network model 180 to obtain a prediction result of the contamination level of the washing tub, and determine to supply fine bubble water based on the prediction result of the contamination level of the washing tub.

Here, the operation information of the washing tub can include the current stroke state of the washing tub 110, which is one of the detergent washing stroke state, the rinsing stroke state, the spin-drying stroke state, and the intermediate stroke state between the previous stroke state and the next stroke state, but this is only an example and is not limited thereto.

In addition, as illustrated in FIG. 11, the neural network model 180 can be pre-trained to predict the contamination level for each washing stroke when input information including at least one of operation information for each washing stroke of the washing tub, the number of times for each washing stroke, and the time for each washing stroke is input.

In addition, the control part 140 can check whether a table of fine bubble water supply conditions according to a preset contamination level prediction result exists when determining the supply of fine bubble water, and if a table of fine bubble water supply conditions according to a preset contamination level prediction result exists, extract a fine bubble water supply condition corresponding to the current contamination level, and determine the fine bubble water supply amount and supply time corresponding to the extracted fine bubble water supply condition.

In this way, the present disclosure can predict the contamination level for each washing stroke using artificial intelligence including a neural network model 180, and by determining the supply amount and supply time of fine bubble water based on this, provide optimal conditions for minimizing contamination of a washing tub with a small amount of fine bubble water.

In this disclosure, artificial intelligence refers to a field that studies artificial intelligence or a methodology for creating it, and machine learning refers to a field that defines various problems in the field of artificial intelligence and studies a methodology for solving them. Machine learning is also defined as an algorithm that improves performance for a task through constant experience with the task.

An artificial neural network (ANN) is a model used in machine learning, and can refer to a model with problem-solving capabilities that consists of artificial neurons (nodes) that form a network by combining synapses. An artificial neural network can be defined by the connection pattern between neurons in different layers, the learning process that updates model parameters, and the activation function that generates the output value.

An artificial neural network can include an input layer, an output layer, and optionally one or more hidden layers. Each layer can include one or more neurons, and the artificial neural network can include synapses connecting neurons to neurons. In an artificial neural network, each neuron can output a function value of an activation function for input signals, weights, and biases input through synapses.

Model parameters refer to parameters that are determined through learning, and include the weights of synaptic connections and the biases of neurons. Hyperparameters refer to parameters that must be set before learning in machine learning algorithms, and include learning rate, number of iterations, mini-batch size, and initialization functions.

The purpose of learning an artificial neural network can be seen as determining model parameters that minimize a loss function. The loss function can be used as an indicator to determine optimal model parameters during the learning process of an artificial neural network.

Machine learning can be classified into supervised learning, unsupervised learning, and reinforcement learning according to the learning method.

Supervised learning refers to a method of training an artificial neural network when labels for training data are given, and the labels can refer to the correct answer (or result value) that the artificial neural network should infer when training data is input to the artificial neural network. Unsupervised learning can refer to a method of training an artificial neural network when labels for training data are not given. Reinforcement learning can refer to a learning method that trains an agent defined in a certain environment to select actions or action sequences that maximize cumulative rewards in each state.

Among artificial neural networks, machine learning implemented with a deep neural network (DNN Network) that includes a plurality of hidden layers is also called deep learning, and deep learning is a part of machine learning. Hereinafter, machine learning is used to mean including deep learning.

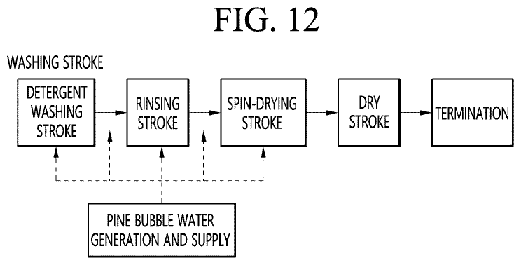

FIG. 12 is a drawing for explaining the timing control of the supply of fine bubble water of a washing treatment device according to one embodiment of the present disclosure.

As illustrated in FIG. 12, the present disclosure can check the current stroke state of the washing tub based on the operation information of the washing tub, check whether the current stroke state is a fine bubble water supply stroke state, determine the supply of fine bubble water if the current stroke state is a fine bubble water supply stroke state, and generate and supply fine bubble water during the corresponding stroke state.

For example, the present disclosure can recognize that the current stroke state is one of a detergent washing stroke state, a rinsing stroke state, a dehydration stroke state, and an intermediate stroke state between a previous stroke state and a next stroke state as a fine bubble water supply stroke state, and generate and supply fine bubble water when performing the corresponding stroke state.

In addition, the present disclosure can check whether a table of pre-set fine bubble water supply conditions by stroke state exists when supply of fine bubble water is determined, extract a fine bubble water supply condition corresponding to the current stroke state if the table of pre-set fine bubble water supply conditions by stroke state exists, determine a fine bubble water supply amount and supply time corresponding to the extracted fine bubble water supply condition, and based on this, fine bubble water can be generated and supplied when the corresponding stroke state is performed.

For example, the fine bubble water supply condition table can include a first fine bubble water supply condition corresponding to a detergent washing stroke state, a second fine bubble water supply condition corresponding to a rinsing stroke state, a third fine bubble water supply condition corresponding to a dehydration stroke state, a fourth fine bubble water supply condition corresponding to an intermediate stroke state between the detergent washing state and the rinsing state, and a fifth fine bubble water supply condition corresponding to an intermediate stroke state between the rinsing stroke state and the dehydration stroke state.

In addition, the present disclosure can determine the supply amount and supply time of fine bubble water corresponding to the basic supply conditions set as default if a table of supply conditions for fine bubble water by preset stroke state does not exist, and based on this, fine bubble water can be generated and supplied when the corresponding stroke state is performed.

In addition, in the present disclosure, when the fine bubble water supply amount and supply time are determined, the fine bubble water supply amount and supply time can be determined to be increased, if the current stroke state of the washing tub is a stroke using washing water with a high level of contamination, and the fine bubble water supply amount and supply time can be determined to be decreased, if the current stroke state of the washing tub is a stroke using washing water with a low level of contamination or not using washing water.

For example, the present disclosure can recognize a stroke using washing water with a high level of contamination if the current stroke state of the washing tub is any one of a detergent washing stroke state, a rinse stroke state, and an intermediate stroke state between the detergent washing stroke state and the rinse stroke state and recognize a stroke using washing water with a low level of contamination if the current stroke state of the washing tub is a spin-drying stroke state or an intermediate stroke state between the rinse stroke state and the spin-drying stroke state.

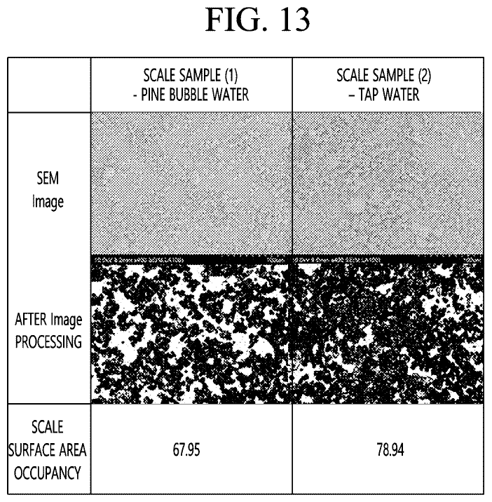

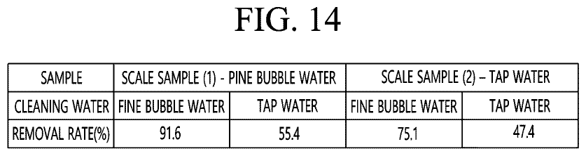

FIGS. 13 and 14 are views for explaining the effect of preventing contamination of a washing tub of a washing treatment device according to one embodiment of the present disclosure.

In the present disclosure, fine bubble water and tap water are respectively dropped onto a stainless steel (SUS) substrate to replace the surface of the stainless steel (SUS) substrate, and then a scale-forming solution is respectively dropped onto the fine bubble water and tap water to form a first scale sample corresponding to the fine bubble water and a second scale sample corresponding to the tap water on the surface of the stainless steel (SUS) substrate.

As illustrated in FIG. 13, when comparing the image of the first scale sample corresponding to fine bubble water and the image of the second scale sample corresponding to tap water on the surface of a stainless steel (SUS) substrate, it can be seen that the surface area occupancy of the first scale sample corresponding to fine bubble water is about 67.96%, and the surface area occupancy of the second scale sample corresponding to tap water is about 78.94%.

In this way, when using fine bubble water, it can be seen that the first scale sample formed on the fine bubble water substitution surface has a low density.

In other words, it can be seen that fine bubble water acts as a hindrance factor that blocks the attachment or deposition of contaminants.

FIG. 14 illustrates the removal rate results according to the volume change before and after cleaning of a first scale sample corresponding to fine bubble water formed on a stainless steel (SUS) substrate surface and a second scale sample corresponding to tap water, respectively, by cleaning with fine bubble water or tap water.

As illustrated in FIG. 14, when the first scale sample corresponding to the fine bubble water is washed with the fine bubble water, the removal rate of the first scale sample is about 91.6%, and when the first scale sample corresponding to the fine bubble water is washed with tap water, the removal rate of the first scale sample is about 55.4%.

In addition, it can be seen that when the second scale sample corresponding to tap water is washed with fine bubble water, the removal rate of the second scale sample is about 75.1%, and when the second scale sample corresponding to tap water is washed with tap water, the removal rate of the second scale sample is about 47.1%.

In this way, when scale is removed using fine bubble water, it can be seen that the scale adhesion is reduced, making it easy to remove contaminants.

In this way, the present disclosure supplies fine bubble water to the inner surface of the outer tub and the outer surface of the inner tub of a washing treatment device before contaminants are attached or deposited, so that the fine bubbles act as a hindrance factor that blocks the attachment or deposition of contaminants, thereby reducing the adhesion of contaminants.

In addition, the present disclosure supplies fine bubble water to the inner surface of the outer tub and the outer surface of the inner tub of a washing treatment device after the contaminants have been attached or deposited, so that the contaminants can be easily removed due to the shock wave or crushing effect generated by the destruction of the fine bubbles.

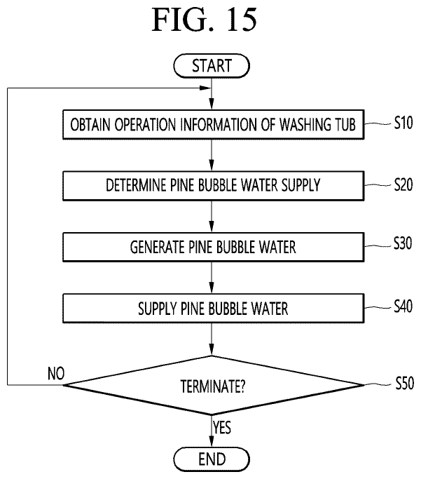

FIG. 15 is a flowchart for explaining a method for preventing contamination of a washing tub of a washing treatment device according to an embodiment of the present disclosure.

As illustrated in FIG. 15, this disclosure can obtain operation information of the washing tub (S10).

Next, the present disclosure can determine the supply of fine bubble water based on the operation information of the washing tub (S20).

Here, the present disclosure can check the current stroke state of the washing tub based on the operation information of the washing tub, check whether the current stroke state is a fine bubble water supply stroke state, and determine the supply of fine bubble water if the current stroke state is a fine bubble water supply stroke state.

For example, the present disclosure can check whether a table of pre-set fine bubble water supply conditions by stroke state exists when determining the supply of fine bubble water, extract fine bubble water supply conditions corresponding to the current stroke state if the table of pre-set fine bubble water supply conditions by stroke state exists, and determine the supply amount and supply time of fine bubble water corresponding to the extracted fine bubble water supply conditions.

In some cases, the present disclosure can obtain contamination level information of a washing tub from a contamination level measuring sensor part and determine the supply of fine bubble water based on the contamination level information of the washing tub.

Here, the present disclosure, when obtaining information on the contamination level of a washing tub, can check whether the contamination level of the washing tub is equal to or greater than a preset reference value, and if the contamination level of the washing tub is equal to or greater than the reference value, determine the supply of fine bubble water.

In another case, the present disclosure can obtain user washing history information from a memory part and determine the supply of fine bubble water based on the user washing history information.

Here, the present disclosure, when obtaining user washing history information, can calculate the total number of times and total time corresponding to a washing stroke using highly contaminated water among the washing strokes performed by the user during a past set period, check whether at least one of the total number of times and total time is equal to or greater than a preset reference value, and determine supply of fine bubble water if at least one of the total number of times and total time is equal to or greater than the reference value.

As another case, the present disclosure can input operation information of a washing tub into a pre-learned neural network model to obtain a contamination level prediction result of the washing tub, and determine the supply of fine bubble water based on the contamination level prediction result of the washing tub.

Next, the present disclosure can generate fine bubble numbers (S30).

Here, if it is determined that fine bubble water is supplied, the fine bubble water supply conditions are obtained, and the fine bubble water can be generated based on the fine bubble water supply amount and supply time corresponding to the fine bubble water supply conditions.

In addition, the present disclosure can supply the generated fine bubble water to the inner surface of the outer tub and the outer surface of the inner tub of the washing tank (S40).

Here, when fine bubble water is generated, the supply of fine bubble water can be controlled based on the fine bubble water supply amount and supply time corresponding to the fine bubble water supply conditions.

Next, the present disclosure can check whether there is a request to terminate the supply of fine bubble water (S50), and if there is a request to terminate the supply of fine bubble water, the fine bubble water supply process can be terminated.

In this way, the present disclosure generates fine bubble water based on operation information of a washing tub and supply it to the inner surface of the outer tub and the outer surface of the inner tub of the washing tub, thereby preventing contamination of the washing tub with a small amount of water and maintaining cleanliness.

In addition, the present disclosure can maintain the hygiene of a washing treatment device by removing the cause of an unpleasant odor, and improve user convenience by eliminating the need for regular maintenance and an independent washing tub cleaning course, thereby increasing customer satisfaction.

In addition, the present disclosure can minimize environmental contamination through water saving by using a small amount of fine bubble water.

In addition, since the present disclosure enables supply of fine bubble water without an additional device such as a pump, the unit price of the product can be minimized.

### Industrial Applicability

According to the washing treatment device according to the present disclosure, by generating fine bubble water based on operation information of the washing tub and supplying it to the inner surface of the outer tub and the outer surface of the inner tub of the washing tub, contamination of the washing tub can be prevented with a small amount of water, thereby maintaining cleanliness, and therefore, the industrial applicability is remarkable.

1. A washing treatment device comprising:
a washing tub in which laundry is stored;
a fine bubble water generation part that generates fine bubble water;
a water supply part that supplies the fine bubble water between an outer tub and an inner tub of the washing tub; and,
a control part that controls the fine bubble water generation part and the water supply part,
wherein the control part obtains operation information of the washing tub, determines whether to supply the fine bubble water based on the operation information of the washing tub, and if it is determined to supply the fine bubble water, controls the fine bubble water generation part to generate the fine bubble water, and controls the water supply part to supply the generated fine bubble water to the inside of the outer tub and the outside of the inner tub of the washing tub.

2. The washing treatment device of claim 1,
wherein the fine bubble water generation part is placed outside the outer tub of the washing tub, and is connected to the water supply part through a duct through which the fine bubble water flows.

3. The washing treatment device of claim 2,
wherein the fine bubble water generation part generates fine bubble water including micro-sized or smaller bubbles according to a control signal from the control part and supplies the generated fine bubble water to the water supply part through the duct.

4. The washing treatment device of claim 1,
wherein the water supply part is disposed in the outer tub of the washing tub and includes a water inlet part which receives the fine bubble water from the fine bubble water generation part; and a water outlet part which discharges the fine bubble water to the inside of the outer tub and the outside of the inner tub of the washing tub.

5. The washing treatment device of claim 4,
wherein the water inlet part of the water supply part is located on the outer surface of the outer tub of the washing tub, and
wherein the water outlet part of the water supply part is located on the inner surface of the outer tub of the washing tub.

6. The washing treatment device of claim 4,
wherein the water outlet part of the water supply part has a disc shape that sprays the fine bubble water in all directions.

7. The washing treatment device of claim 4,
wherein the water outlet part of the water supply part has a stripe shape that sprays the fine bubble water in both directions.

8. The washing treatment device of claim 1,
wherein the control part, when obtaining the operation information of the washing tub, obtains operation information including the current stroke state of the washing tub from the control system that controls the operation of the washing tub.

9. The washing treatment device of claim 1,
wherein the control part,
when obtaining the operation information of the washing tub, if a user input for selecting at least one washing menu among a plurality of washing menus is received, checks the stroke sequence and time for each administrative process corresponding to the selected washing menu, and if an operation command is input, obtains the operation information of the washing machine based on the stroke sequence and the time for each administrative process.

10. The washing treatment device of claim 1,
wherein the control part, when obtaining the operation information of the washing tub, if the preset time arrives, checks the stroke sequence and time for each administrative process corresponding to the preset washing menu, and obtains the operation information of the washing tub based on the stroke sequence and time for each administrative process.

11. The washing treatment device of claim 1,
wherein the control part,
when determining whether to supply the fine bubble water, checks the current stroke state of the washing tub based on the operation information of the washing tub, checks whether the current stroke state is the fine bubble water supply stroke state, and if the current stroke state is the fine bubble water supply stroke state, determines the supply of the fine bubble water.

12. The washing treatment device of claim 11,
wherein the control part,
When determining the supply of the fine bubble water, checks whether a table of fine bubble water supply conditions for each pre-set stroke state exists, and if the table of fine bubble water supply conditions for each pre-set stroke state exists, extracts the fine bubble water supply conditions corresponding to the current stroke state, and determines the supply amount and supply time of the fine bubble water corresponding to the extracted fine bubble water supply conditions.

13. The washing treatment device of claim 12,
wherein the control part,
when determining the fine bubble water supply amount and supply time, if the current stroke state of the washing tub is an stroke state using highly contaminated washing water, determines to increase the fine bubble water supply amount and supply time, and if the current stroke state of the washing tub is an stroke state using low-contaminated washing water or not using washing water, determines to decrease the fine bubble water supply amount and supply time.

14. The washing treatment device of claim 1,
wherein the control part,
when controlling the fine bubble generation part and the water supply part, obtains the fine bubble water supply condition when the fine bubble water supply is determined, and controls the fine bubble water generation of the fine bubble water generation part and the opening and closing of the water supply part based on the fine bubble water supply amount and supply time corresponding to the fine bubble water supply condition.

15. A method for preventing contamination of a washing tub of a washing treatment device including a washing tub, comprising:
obtaining operation information of the washing tub;
determining the supply of the fine bubble water based on the operation information of the washing tub;
generating the fine bubble water; and
supplying the generated fine bubble water to the inside of the outer tub and the outside of the inner tub of the washing tub.
